(19) United States
(12) Patent Application Publication
(10) Pub. No.: US 2010/0032243 A1
(43) Pub. Date: Feb. 11, 2010

(54) FORKLIFT

(76) Inventors: Mario HEIDRICH, Burbach (DE); Arnold Vetter, Wilnsdorf (DE)

Correspondence Address: K.F. ROSS P.C., 5683 RIVERDALE AVENUE, SUITE 203 BOX 900, BRONX, NY, 10471-0900, US

(21) Appl. No.: 12/534,191

(22) Filed: Aug. 3, 2009

(30) Foreign Application Priority Data
Aug. 6, 2008 (DE) 102008036542.4

(51) Int. Cl. B66F 9/12

(52) U.S. Cl. 187/237

(57) ABSTRACT

An industrial truck having at least one load pick-up device (1), in particular a lift having two fork arms, wherein provided for mounting the load pick-up device (1) is at least an upper hook (4) associated with the latter that when mounted engages a part of a pick-up carriage, is formed such that the retaining element (7) is provided with at least one open catch mouth (11) for a lock part (9).

### FIELD OF THE INVENTION

The invention relates to an industrial truck having at least one load pick-up device that is provided with at least an upper hook that supports it on a part of a pick-up carriage and that has at least one retaining element that in a holding position inhibits movement of the load pick-up device and that itself can be held on the hook by a lock part, and relates to a lift fork having two fork arms and two hooks with respective fork backs for supporting the weight of the lift fork and where necessary a load held thereon on a pick-up carriage of a motor vehicle or industrial vehicle, the hooks when installed engaging in a part of the pick-up carriage and a retaining element that inhibits movement of the fork arms and that can be moved up and down being associated with at least one hook and being held by a lock part to the hook.

### BACKGROUND OF THE INVENTION

Industrial trucks of the above-described type are formed for example as fork lifts, construction vehicles, and the like. Their load pick-up device can be formed for instance by two arms of a lifting fork, but also by single fork arms, booms for carpets, textiles, rolls of paper, coils, or the like, or other carrying parts. The load pick-up device should be exchangeable on a pick-up carriage and it should be possible to adjust them with respect to their horizontal orientation. The pick-up carriage is typically formed in accordance with ISO 2328 and therefore includes a plurality of recesses for fixing the load pick-up device used.

In order to be able to detachably connect the load pick-up device to the pick-up carriage, holders are known that can each be fixed, for instance welded, to a back side of a load pick-up device, for instance to a fork back. Such holders are described for instance in DIN 15178 (now rescinded) and include two downward facing parts that end in a vertical hook formation and, as a retaining element for the load pick-up device, a spring-actuated bolt that is arranged in a bore provided between these parts and that can be moved using a tension lever. In the connected position, the hook projection engages the upper edge of the pick-up carriage in order thus to support the load pick-up device. In order to prevent the bolt from falling out, it can be secured above the hook by means of a lock part. Embodying the lock part as a securing pin, for instance a spiral pin, that can be driven transversely into a bore is known. Installation of such an lock part is complex, and in addition this initially loose lock part is at risk of being lost.

### OBJECT OF THE INVENTION

The object of the invention is to improve the mounting for the retaining element while avoiding the above-described disadvantages.

### SUMMARY OF THE INVENTION

The invention solves this problem using an industrial truck wherein the retaining element is provided with at least one open catch mouth for the lock part and with a fork lift wherein the retaining element is provided with at least one open catch mouth for an insertable lock part installable without tools.

Using the invention, it is not necessary to drive in a separate lock part, but instead the lock part can be inserted laterally into the open catch mouth of the retaining element.

In particular, for simple assembly the lock part can be inserted into the catch mouth of the retaining element above the hook, thus in an easily accessible and visually controllable manner.

Since the retaining element can be fitted without tools into a cutout of the hook and the lock part can be inserted without tools into the catch mouth of the mount, the entire assembly can be performed without using tools so that the result is significantly less work on site.

Using downward spring actuation for the retaining element can cause the latter to engage automatically in different recesses of the pick-up carriage and thus hold it in place.

In particular, an actuator can move the retaining element selectively between an upper position and a lower position, and in the lower position the movement inhibition of the load pick-up device, specifically in particular preventing transverse displacement, can be effected by engaging in a recess of the pick-up carriage.

An operating lever for the actuator can be particularly advantageous with a dual function, simultaneously acting as a support for the retaining element. This then does not constitute a separate component and thus cannot be lost.

In particular the lock part can also be integral with the operating lever, for instance a lock part that bridges outer sides of the operating lever and formed by sheet metal that has been multiply bent.

The retaining element advantageously forms a lock part that runs essentially horizontally and that extends the full width of the retaining element and that can be engaged laterally in the mouth of the retaining element that itself is supported in a stable and tilt-free manner when installed on an upper surface of the hook. Because of its position atop the upper surface of the hook, the retaining element is truly locked, which ensures that it is reliably held.

For failproof holding of the retaining element in the mount, the catch mouth preferably ends in a seat for the lock part of the hook, this seat opening vertically downward, in particular in the installed position, from the catch mouth and ending at an upper support surface that engages the lock part in the installed position. This ensures particularly good engagement of the retaining element and its reliable hold without the risk of its falling out of the mount. The spring biasing and the weight of the retaining element press the retaining element against the support surface.

For simple production and management, the retaining element itself, with a more or less continuous round peripheral shape apart from the catch mouth, can be a bolt that is prestressed vertically downward and that when in a holding position engages in a recess in the pick-up carriage.

If the pick-up carriage includes a plurality of adjacent recesses and the mount, depending on the position of the load pick-up device relative to a vertical longitudinal center plane in the vehicle, engages in different recesses of the pick-up carriage, this makes possible lateral displacement of the load pick-up device. Using the actuator, any load pick-up device can lock onto the different recesses by depression of the retaining element by spring tension.

A lift fork having an inventive embodiment of a retaining element and a lock part that can be installed tool-free is claimed separately.

### BRIEF DESCRIPTION OF THE INVENTION

Additional advantages and features of the invention derive from an embodiment of the subject matter of the invention, which embodiment is illustrated in the drawings and described in the following.

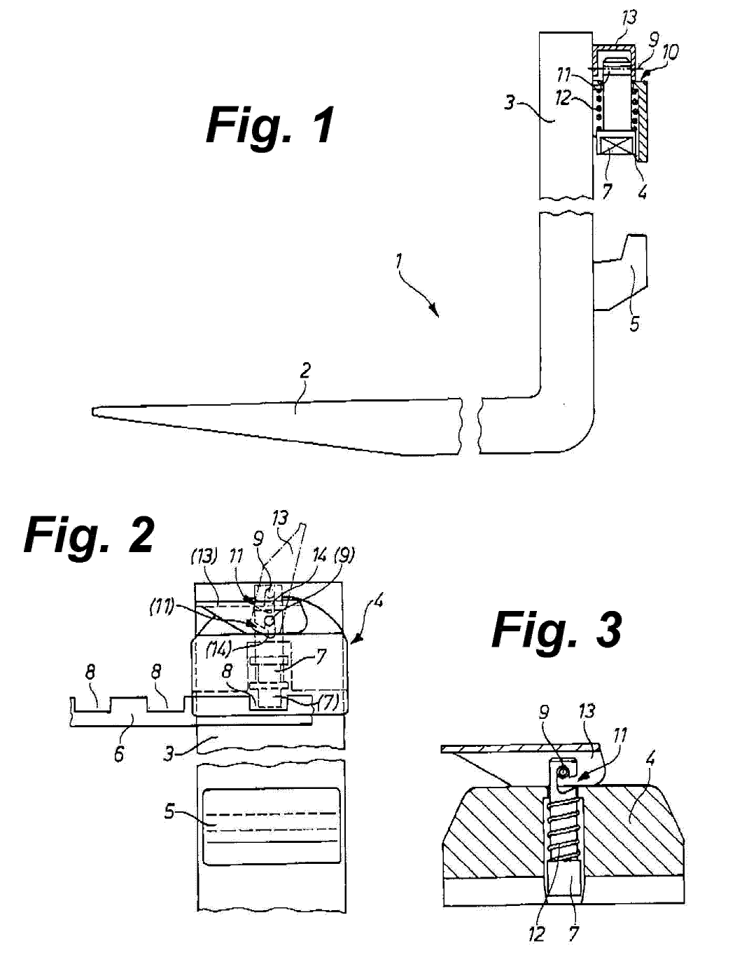

FIG. 1 is a side elevation of a load pick-up device formed as an arm of a fork lift and formed according to the invention with a retaining element inserted through a hook from below and held by a pin;

FIG. 2 is a view of the upper hook in accordance with FIG. 1 from the rear, with an up or down movement (indicated by dashed lines) of the retaining element effected by an actuator;

FIG. 3 is a front cross-sectional view of a hook made according to the invention with an operating lever in the closed position of an actuator and with a lowered mount;

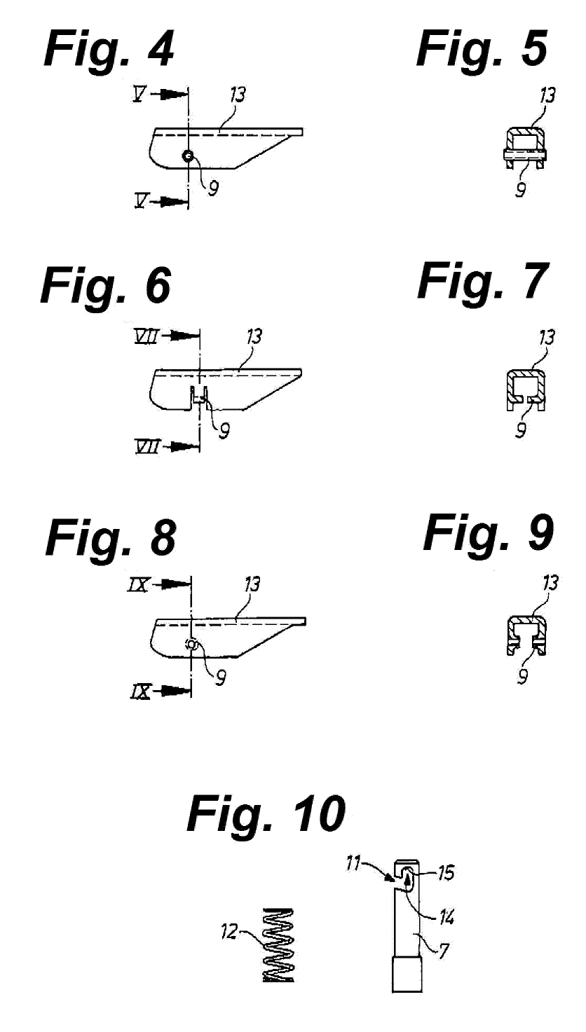

FIG. 4 is a section through the operating lever, seen from the back;

FIG. 5 is a section along line V-V in FIG. 4;

FIG. 6 is a section of an alternative operating lever, seen from the back;

FIG. 7 is a section along line VII-VII in FIG. 6;

FIG. 8 is a section of another alternative operating lever, seen from the back;

FIG. 9 is a section along line IX-IX in FIG. 8;

FIG. 10 is a separated view the retaining element with the helical spring that acts downward in accordance with FIG. 3;

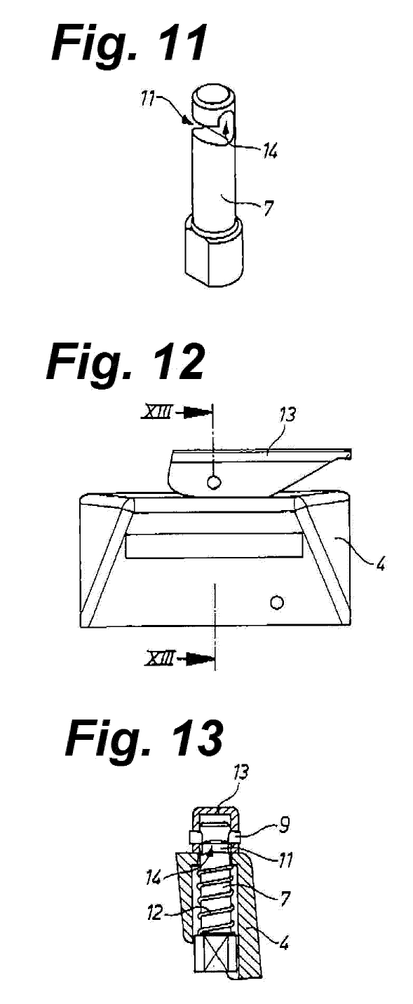

FIG. 11 is a perspective view of the retaining element shown separately in FIG. 10;

FIG. 12 is a view from below of the upper hook with the actuator closed; and

FIG. 13 is a cross-section along line XIII-XIII in FIG. 12.

### SPECIFIC DESCRIPTION

FIG. 1 shows as load pick-up device 1 for an industrial truck, for instance a fork lift, a single fork arm that when installed has a horizontal fork blade 2 and a fork back 3 that is perpendicular thereto and that extends vertically. The latter carries an upper hook 4 and a lower hook 5. The upper hook 4 is provided for engaging over a support bar 6 of a pick-up carriage (not shown), for instance a cross-rail according to ISO 2328, in order to hold the fork arms or another load pick-up device 1 on the pick-up carriage individually or in a pair. The lower hook 5 is provided for limiting the freedom of movement of the pick-up device 1, but because of its orientation cannot provide any support for the weight of the load pick-up device 1 or the load it holds. The load is therefore suspended completely from the upper hook 4.

In accordance with the invention, each upper hook 4 has a retaining element 7 that is here formed like a pin and in accordance with the drawing can be moved between a raised release position and a lowered holding position. In the holding position, it prevents movement by the load pick-up device 1 in that it then engages in a recess 8 on the support bar 6. In order to make it possible to have a plurality of different locked positions for the load pick-up device 1 across the transverse extension of the support bar 6, a plurality of such recesses 8 can be provided over the transverse length of the support bar 6 and the retaining element 7 can engage therein and is prestressed for securing via spring tension that is described in greater detail below.

The retaining element 7 is typically dimensioned such that it can be inserted from below into a bore (not shown here) of the hook 4 and then held in the upright installed position. In order to prevent the retaining element 7 from falling downward and out, it can be held on the hook 4 using a lock part 9.

In its installed position, the lock part 9 is above an upper surface 10 of the hook 4. In order to facilitate the connection between the retaining element 7 and the lock part 9, the retaining element 7 is provided with at least one laterally open catch mouth 11 for the lock part 9 so that the latter does not have to be driven into a transverse bore or the like but rather can be fitted from the side into the catch mouth 11 of the retaining element 7 above the hook 4.

This insertion can be performed with no tools, and the retaining element 7 can also be inserted into the bore of the hook 4 from below with no tools so that assembly is overall very simple and can be accomplished quickly.

For this type of assembly the inserted retaining element 7 can be moved upward such that the catch mouth 11 is accessible above the hook 4 so that the lock part 9 can be fitted in from the side.

In addition, the illustrated retaining element 7 is spring biased downward by a spring 12. After the lock part has been inserted into the retaining element 7, the spring tension automatically moves it so that the lock part 9 is clamped against the surface 10 of the hook 4.

Moreover, an actuator can move the retaining element 7 selectively between the above-described upper position and the lowered holding position. This actuator is operated via a lever 13, which is shown here as a pivotal knee lever. This operating lever 13 simultaneously has a dual function as a support for the lock part 9. In order to install the actuator, at its upper area the inserted retaining element 7 is therefore manually connected via the catch mouth 11 to the lock part 9 and with this one assembly step retention of the retaining element 7 is also simultaneously effected.

The lock part can for instance be an elongated body that connects two cheeks of the operating lever 13 (FIG. 5) or alternatively can be integrally formed with the operating lever (FIG. 9), for instance by punched tabs in the sides that extend inward due to multiple bending and thus form structure that the catch mouth 11 can engage.

Either way, the lock part 9 forms a projecting brace that runs essentially horizontally, that projects laterally past the retaining element 7, that in the assembled position bears on an upper surface 10 of the hook 4, and that is retained in this above-described position by spring tension.

To make this retention possible, the lock part 9 is particularly securely held in that the catch mouth 11 ends in a seat 14 for the lock part 9 of the hook 4 that also acts as support. It opens into the catch mouth 11 extending vertically upward therefrom to a support surface 15 that engages the element 9 when it is in the installed position. Spring tension presses this support surface 15 down against the lock part 9.

A lifting fork with two fork arms 1 and a retaining element 7 in the inventive design and connection to a lock part 9 is also claimed.

1. An industrial truck having at least one load pick-up device, in particular a fork having two arms, the load pick-up device being provided with at least an upper hook that supports it on a part of a pick-up carriage and that has at least one retaining element that in a holding position inhibits movement of the load pick-up device and that itself can be held on the hook by a lock part wherein the retaining element is provided with at least one open catch mouth for the lock part.

2. The industrial truck in accordance with claim 1 wherein the lock part can be inserted into the catch mouth of the retaining element above the hook.

3. The industrial truck in accordance with claim 1 wherein the retaining element can be inserted without tools into a bore in the hook and the lock part can be inserted without tools into the catch mouth of the retaining element.

4. The industrial truck in accordance with claim 1 wherein the retaining element is formed as a pin that in the installed position is upright and that can be moved upward such that the catch mouth is above the hook.

5. The industrial truck in accordance with claim 4 wherein the retaining element is spring biased downward.

6. The industrial truck in accordance with claim 1 wherein the retaining element can be selectively moved between an upper position and a lower position by means of an actuator.

7. The industrial truck in accordance with claim 6 wherein an operating lever for the actuator carries the lock part.

8. The industrial truck in accordance with claim 7 wherein the lock part is integral with the operating lever.

9. The industrial truck in accordance with claim 1 wherein the retaining element has a lock part that runs essentially horizontally and that projects across the width of the retaining element and that is supported when installed on an upper surface of the hook.

10. The industrial truck in accordance with claim 1 wherein the catch mouth ends in an seat for the lock part of the hook.

11. The industrial truck in accordance with claim 10 wherein in the installed position, the seat opens vertically downward into the catch mouth and ends upward at a support surface that engages the lock part in the installed position.

12. The industrial truck in accordance with claim 11 wherein in the installed position the support surface is prestressed against the lock part of the hook by spring tension.

13. The industrial truck in accordance with claim 1 wherein the retaining element is a vertically downwardly prestressed bolt that in a holding position engages in a recess of the pick-up carriage.

14. The industrial truck in accordance with claim 13 wherein the pick-up carriage includes a plurality of adjacent recesses and the retaining element, depending on the position of the load pick-up device relative to a vertical longitudinal center plane in the vehicle engages in different recesses of the pick-up carriage.

15. A lift fork having two fork arms and two hooks with respective fork backs for supporting the weight of the lift fork and where necessary a load held thereon on a pick-up carriage of a motor vehicle or industrial vehicle, wherein the hooks when installed engage in a part of the pick-up carriage and a retaining element that inhibits movement of the fork arms and that can be moved up and down is associated with at least one hook and can be held by a lock part to the hook wherein the retaining element is provided with at least one open catch mouth for an insertable lock part installable without tools.

16. In a fork-lift truck having a front-end carriage with a transversely extending carriage bar formed with a plurality of upwardly open recesses, a fork comprising:
a horizontal arm;
a back extending upward from the horizontal arm;
an upper hook fixed on the back and hookable over the carriage bar to hang the fork from the bar;
a vertically throughgoing hole in the hook above the bar;
a bolt vertically slidable in the hole and having a lower end engageable in the recesses of the bar to transversely lock the fork to the bar and an upper end formed with a laterally opened mouth having a downwardly directed upper surface;
an actuator on the hook above the hole having a pair of sides flanking the upper end of the bolt;
a lock pin bridging and fixed in the sides and engageable laterally in the mouth; and
a spring urging the bolt downward and thereby, when the pin is engaged in the mouth, pressing the upper surface of the mouth downward against the pin, the actuator being shaped such that in a position lying on the hook the pin and the bolt are in a lower position with the lower end of the bolt projecting downward from the hook into one of the recesses and in a position standing up from the hook the bolt and the pin are in an upper position with the bolt retracted upward in to the hook and not engageable in any of the recesses.

17. The fork defined in claim 16 wherein the actuator is of U-section.

18. The fork defined in claim 16 wherein the spring is a coil spring surrounding the bolt.

19. The fork defined in claim 16 wherein the upper surface is generally downwardly concave.

20. The fork defined in claim 16 wherein the mouth is L-shaped.
